(19) United States
(12) Patent Application Publication
(10) Pub. No.: US 2001/0009214 A1
(43) Pub. Date: Jul. 26, 2001

(54) Hydraulic damper for suspension systems

(76) Inventor: Akira Tanaka, Shizuoka (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/767,100

(22) Filed: Jan. 22, 2001

(30) Foreign Application Priority Data
Jan. 21, 2000 (JP) 2000-17788

(51) Int. Cl. F16F 9/34

(52) U.S. Cl. 188/275; 188/322.15; 267/186

(57) ABSTRACT

A hydraulic damper comprises a first chamber and second chamber separated by a wall. The wall contains at least one passage that extends generally between the first chamber and the second chamber. The passage is opened and closed by a valve member. The valve member is formed by a first sheet and a second sheet that generally form a fluid chamber. The fluid chamber is in direct communication with the first chamber through an aperture in the first sheet and in selective communication with the second chamber when the second sheet moves away from the first sheet. The first sheet also can move from the wall to allow fluid communication between the passage.

### RELATED APPLICATIONS

This application claims priority to Japanese Patent Application No. 2000-17788, filed on Jan. 21, 2000, which application is hereby expressly incorporated by reference in its entirety.

### BACKGROUND OF THE INVENTION

1. Field of the Invention

The present invention is generally related to hydraulic dampers for use in suspension systems. More particularly, the present invention is related to a valve construction for use in such dampers.

2. Related Art

Suspension systems generally comprise at least one damper that is arranged to attenuate oscillation of a sprung mass relative to an unsprung mass. Often, the damper is a hydraulic damper that operates in cooperation with a suspension spring to smooth operation of the vehicle. The spring absorbs and returns energy during relative movement of its two ends and the damper dissipates that energy during relative movement of its two ends.

To dissipate the energy, the damper generally comprises at least a pair of chambers that are in fluid communication with each other. As fluid flows between the chambers, energy is dissipated and the oscillation of the vehicle is attenuated. With reference now to FIG. 1, a portion of a damper 10 is illustrated therein. As will be described, the damper 10 comprises a set of valved openings and a non-valved orifice that place a pair of chambers in fluid communication.

With continued reference now to FIG. 1, the damper 10 generally comprises an outer cylinder 12. The outer cylinder 12 defines a bore within which a piston 14 is reciprocally mounted. The piston 14 generally divides the bore into an upper chamber 16 and a lower chamber 18. The piston 14 serves as a valve seat member and is attached to one end of a piston rod 20 that extends into the cylinder 12.

The oil chambers 16, 18 are filled with working oil. The piston 14 is provided with communication holes and an orifice that interconnect the oil chambers. The communication hole is opened and closed with a ring-shaped sheet valve. Thus, working oil can flow between the oil chambers 16, 18 when the piston rod 20 and the cylinder 12 move in extending and contracting directions. Additionally, damping forces are produced by this flow, which damping forces attenuate oscillations that can result from shocks caused by irregularities in the road surface.

In the illustrated arrangement, in a low speed range when the piston 14 moves through a portion of the damper 10 at a sufficiently low speed, the sheet valve remains closed because the pressure of working oil in one oil chamber is insufficient to force the sheet valve open. Accordingly, the working oil flows through the orifice formed in the piston into the other oil chamber. When the piston speed reaches a medium or high value, the working oil pressure increases and working oil flows through the communication hole bored in the piston and pushes open the sheet valve. The working oil, therefore, can enter the other oil chamber by flowing through both the orifice and the sheet valve.

With reference to FIG. 6, the damping force characteristic of a typical hydraulic damper as described above is graphically illustrated with a broken line. As illustrated, in the low speed range, the curve is secondary in degree because working oil flows only through the orifice. In the medium and high speed ranges, the curve becomes a straight line because the pressure generated in the chamber toward which the piston 14 is moving opens the sheet valve. This construction, however, results in a damper that provides inadequate damping in low speed operation due to the differences in flow rates and the associated differences in damping forces.

Accordingly, an improved damping valve structure has been proposed in Japanese laid-open patent application No. Hei-11-923173. In this arrangement, which is illustrated in FIG. 1, a pair of disks 22, 24 are respectively placed over and under a main body 26 of the piston 14. A respective pair of sub-layers 28, 30 are provided to open and close a set of ports 32, 34 bored through the disks 22, 24. The sub-layers 28, 30 are made to deflect more easily by making their deflection rigidity smaller than that of a corresponding set of main valves 36, 38, which can be annular leaf valves.

This damping valve structure provides a linear damping force characteristic in the low piston speed range as the working oil in one oil chamber, such as the upper chamber 16, flows through a communication hole 40 and the port 34of the piston 14 and as the oil pressure opens the sub-layer 30 and flows into the other oil chamber 18. A similar process occurs as the working oil flows in the opposite direction, as the working oil flows through a communication hole 42 and the port 32 and opens the sub-layer 28.

When the damping valve structure shown in FIG. 1 is used, the number of components undesirably increases because the disks 22, 24, which include the ports 32, 34 are required. Moreover, because the disks 22, 24 are geometrically complicated and difficult to form by casting or machining, the disks are expensive to manufacture. Furthermore, providing the disks 22, 24 increase the axial dimension of the assembled damper relative to a system without such disks. The increase in the axial dimension also undesirably decreases the available clearance and travel distance of the suspension system.

### SUMMARY OF THE INVENTION

Thus, one object of the present invention is to provide a hydraulic damper capable of providing appropriate damping force characteristics in a low piston speed range while maintaining a simplified structure having fewer components than previous constructions.

Accordingly, one aspect of the present invention comprises an apparatus comprising an outer housing with the outer housing defining at least a first chamber and a second chamber. A moveable wall is interposed between the first chamber and the second chamber. The moveable wall has at least one passage extending in a generally axial direction. The passage is in substantially unobstructed fluid communication with the first chamber. A valve member is attached to the moveable wall and is positioned between at least a portion of the second chamber and at least a portion of the moveable wall. The valve member selectively closes the at least one passage. The valve member comprises a first layer and a second layer. The first layer is interposed between the moveable wall and the second layer. A chamber is defined between the first layer and the second layer. An opening is defined within the first layer and the chamber is in fluid communication with the passage through the opening.

Another aspect of the present invention comprises a hydraulic damper comprising a cylinder body that has a bore. A piston rod extends into the bore with a piston being connected to the piston rod. The piston contains a first set of passages and substantially separates a first chamber and a second chamber within the bore of the cylinder body. The first set of passages extends generally between the first chamber and the second chamber. A first sheet valve selectively opens and closes the first set of passages. The first sheet valve contains a fluid chamber that is in substantially continuous communication with the first chamber and in selective communication with the second chamber.

A further aspect of the present invention involves a damper comprising a first chamber and a second chamber. A moveable wall is positioned between the first chamber and the second chamber and means are provided for placing the first chamber and the second chamber in multiple degrees of selective communication such that increasing levels of communication result from increasing pressure differentials in the chambers or increasing speeds of the moveable wall.

### BRIEF DESCRIPTION OF THE DRAWINGS

These and other features, aspects and advantages of the present invention will now be described with reference to the following drawings of a preferred embodiment that is intended to illustrate and not to limit the present invention. The drawings comprise seven figures.

FIG. 1, which was described above, depicts a prior valving arrangement.

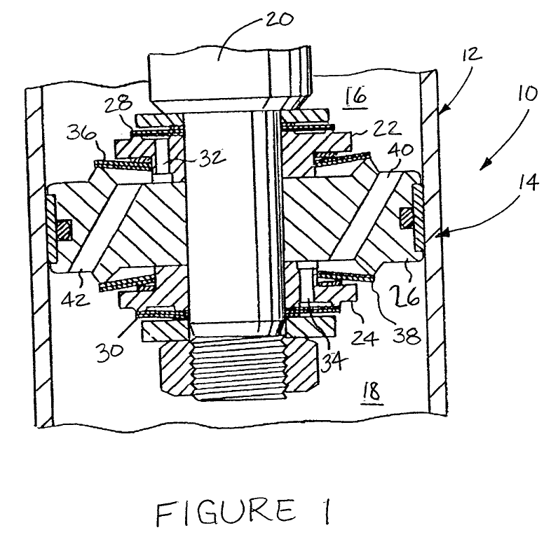

FIG. 2 is a partially sectioned elevation view of a pair of hydraulic dampers that are configured and arranged in accordance with certain features, aspects and advantages of the present invention and that are interconnected with a pressure regulator that also is configured and arranged in accordance with certain features, aspects and advantages of the present invention.

FIG. 3 is an enlarged sectioned view of a portion of the damper of FIG. 2.

FIG. 4 is a further enlarged sectioned view of a portion of the damper of FIG. 2.

FIG. 5 is an enlarged sectioned view of a portion of the pressure regulator of FIG. 2.

FIGS. 6 and 7 are graphical depictions of response characteristic curves of the suspension system of FIG. 2 compared with a suspension system featuring dampers arranged in a manner similar to that illustrated in FIG. 1.

### DETAILED DESCRIPTION OF THE PREFERRED EMBODIMENT OF THE INVENTION

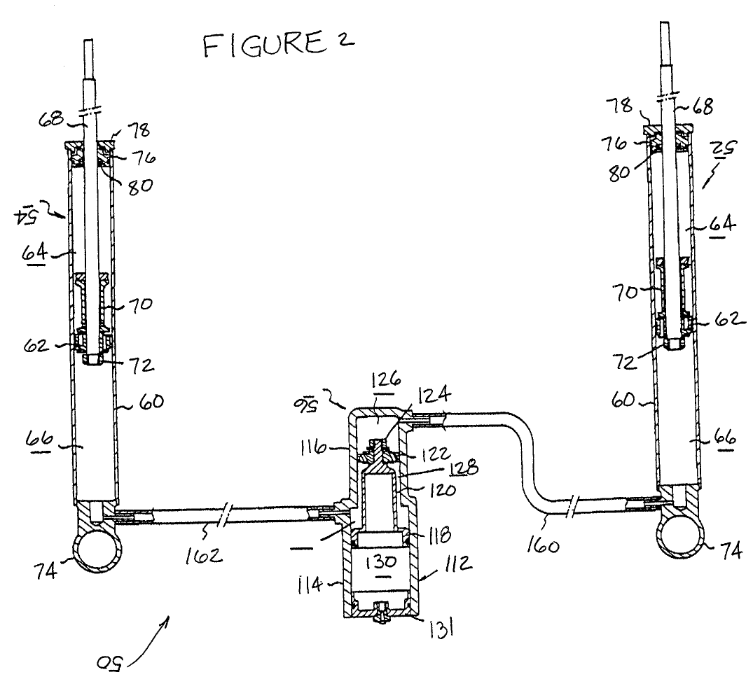

With reference now to FIG. 2, a vehicle suspension system 50 is illustrated therein. The vehicle suspension system 50 preferably is used for suspending, for example, right and left front wheels of a four-wheeled vehicle such as an automobile. Of course, the vehicle suspension system can be used in other applications, such as snowmobiles, all terrain vehicles, motorcycles and the like. Additionally, some aspects of the present invention can be used to support components of other vehicles, such as seats on watercraft and the like. The illustrated suspension system 50 comprises a pair of hydraulic cylinders (i.e., a left damper 52 and a right damper 54). The cylinders 52, 54 are interconnected with a pressure regulator 56. As will be explained below, either the cylinders 52, 54, the pressure regulator 56 or both can be constructed in accordance with certain features, aspects and advantages of the present invention.

With reference initially to FIGS. 2-4, a presently preferred construction of the illustrated cylinders 52, 54 will be described. As will be appreciated, the overall construction is similar to that described above; however, the construction differs in manners that will be described in more detail below. Generally speaking, the illustrated arrangement features a different valving arrangement to better control flow between the two chambers of the damper or cylinder.

With continued reference to FIGS. 2-4, the cylinders 52, 54 each generally comprise an outer cylinder body 60. Because both cylinders 52, 54 in the illustrated arrangement are identical in construction, only one of the cylinders will be described. The outer cylinder body 60 defines a bore within which a piston 62 is reciprocally mounted. The piston 62 generally divides the bore into an upper chamber 64 and a lower chamber 66. The piston 62 serves as a valve seat member and is attached to one end of a piston rod 68 that extends into the cylinder body 60. In the illustrated arrangement, the piston rod 68 extends downward into the bore of the cylinder body 60 such that the piston rod 68 is attached to the body of the supported vehicle and the cylinder body 60 is attached to the wheel of the supported vehicle. Of course, the arrangement also could be reversed. In addition, the use of the terms upper and lower with respect to the chambers is for convenience only and should not limit the application or construction of the present invention. For instance, in some arrangements, the damper construction may be used to damp movement between two components that use a horizontally disposed damper.

The piston 62 in the illustrated arrangement is secured to a lower portion of the piston rod with a guide sleeve 70 and a threaded member 72, such as a nut. This arrangement results in the piston 62 being sandwiched between a shoulder of the guide sleeve 70 and the threaded member 72. Of course, other techniques can be used to attach the piston 62 to the piston rod 68. The piston 62, the guide sleeve 70 and the threaded member 72, along with other aspects of the present invention, will be described in more detail below.

With continued reference to FIG. 2, a connection member 74 is fitted into the lower end of the cylinder body 60. The connection member 74 provides a location to which the illustrated cylinder body 60 can be connected to the wheel or other supporting component. The illustrated cylinder body 60 also is provided with a guide member 76 and a cap 78. The guide member 76 and the cap 78 are fitted within the upper portion of the cylinder bore defined by the cylinder body 60. An oil-tight sealing arrangement also preferably is provided between the cylinder body 60 and the piston rod 68. In the illustrated arrangement, this sealing arrangement comprises an oil seal 80 that is held to the inside circumference of the guide member 76. The oil seal 80 generally is in sliding contact with the outside circumference of the piston rod 68. Thus, the oil seal 80 and the guide member 76 help to form a generally liquid tight seal between the cylinder body 60 and the piston rod 68.

As described above, the bore of the cylinder body 60 is divided into the upper chamber 62 and the lower chamber 64 in the illustrated arrangement. The oil chambers 64, 66 are filled with working oil. The piston 62 is provided with communication holes and an orifice that interconnect the oil chambers 64, 66. The communication holes are opened and closed with valves that will be described in more detail below. The valves, as will be explained, provide, at least in part, for multiple degrees of selective flow through the communication holes such that the flow rate can be varied depending upon differential pressures or speed of piston movement. Thus, working oil can flow between the oil chambers 64, 66 when the piston rod 68 and the cylinder body 60 move in extending and contracting directions. Additionally, damping forces are produced by this flow, which damping forces attenuate oscillations that can result from shocks to the vehicle caused by irregularities in the road surface.

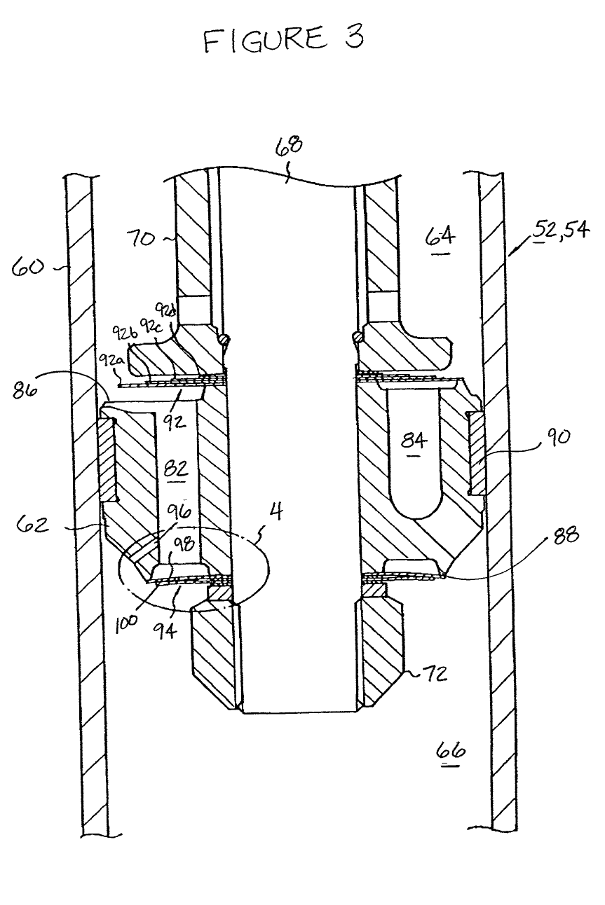

Both the upper chamber 64 and the lower chamber 66 are filled with working oil. With reference to FIG. 3, multiple communication holes extend through the piston 62 in an axial direction. The communication holes in the illustrated arrangement comprise two sets of holes: a first set of holes 82 are provided to allow flow from the upper chamber 64 to the lower chamber 66 and a second set of holes 84 are provided to allow flow from the lower chamber 66 to the upper chamber 64. As illustrated, the piston 62 comprises a stepped upper surface 86 and a stepped lower surface 88. The stepped surfaces 86, 88 allow only one end of each of the sets of holes 82, 84 to be closed by seals while relatively free communication with the respective chamber occurs at the other end of the sets of holes 82, 84. Incidentally, this piston construction allows both sets of holes 82, 84 to be bored through the piston are a single hole circle.

A sealing member or bushing 90 is provided within a circumferential groove formed about a portion of the piston 62. The member 90 provides a wiping edge that slides along the inner surface of the cylinder body 60. The member 90 also can be formed of a lubricious material such that the member 90 slides more easily over the inner surface of the cylinder body 60.

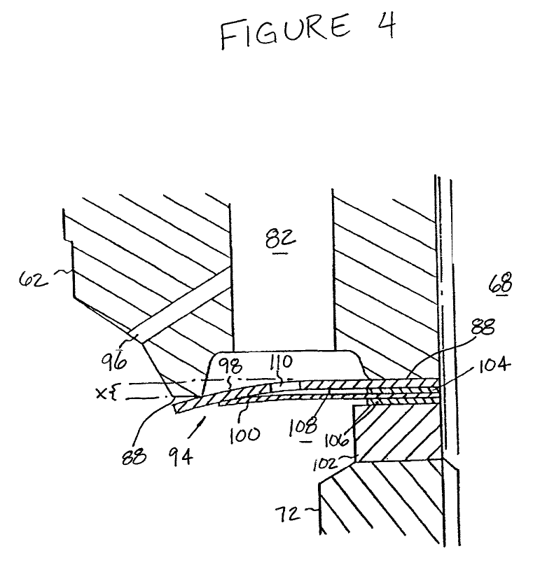

As described above, ring-shaped sheet valves 92, 94 are provided to selectively close the sets of holes 82, 84. These valves can be placed over and under the piston 62. With continued reference to FIGS. 3 and 4, a small diameter orifice 96 can extend through a portion of the piston 62 to place the upper chamber 64 and the lower chamber 66 in constant fluid communication. The illustrated orifice 96 can extend at an angle into one of the sets of holes 82, 84. Preferably, the orifice 96 extends upward at an angle to provide better flow characteristics and to allow settling of the working oil during long periods of non-use.

With reference still to FIG. 3, the sheet valve 92 that is positioned on at least a portion of the upper surface 86 of the piston 62 is built up by laminating four layers 92a, 92b, 92c, 92d together. Preferably, the layers 92a, 92b, 92c, 92d each have a different diameter. In addition, while the illustrated layers are laminated together, it is anticipated that the layers 92a, 92b, 92c, 92d can be simply stacked together or can be slightly spaced from each other in the other arrangements. Of course, a combination of these techniques also can be used.

Preferably, the inside circumferential portions of the layers 92a, 92b, 92c, 92d are sandwiched together and secured between a portion of the piston 62 and a portion of the sleeve 70. In addition, the layers also preferably are secured with their outer circumferential portions being deflectable and with the outer circumference of the largest diameter sheet 92a, being made to tightly contact the upper surface 86 of the piston 62. The tight contact between the valve 92 and the upper surface of the piston 62 advantageously results in a preloading of the valve 92 and results in a deflection of the valve 92.

The other sheet valve 94 advantageously is constructed with a main layer 98 and a sub-layer 100 having different diameters. Preferably, the main layer 98 has a slightly larger diameter than the sub-layer 100. More preferably, the inner circumferential portions of the main layer 98 and the sub-layer 100 are fixed together in any suitable manner and with the outer circumferential portions of the main layer 98 and the sub-layer 100 being deflectable. Having the layers fixed in this manner takes advantage of the increase in flexibility toward the outer diameter of the layers. Of course, other constructions can be used in which a more flexible material is used and the outer and inner portions are fixed while the middle portion can deflect. In addition, some constructions in which the outer portion is fixed and the inner portion is deflectable also can be used to varying degrees of utility.

With continued reference to FIG. 4, by attaching the layers 98, 100 with the sublayer 100 on the outer side (i.e., lower than the main valve 98 in the arrangement illustrated in FIG. 4), the inner circumferential portions of both of the layers 98, 100 are sandwiched among a washer 102, a pair of shims 104, 106, the piston 62 and are secured in position with the threaded fastener 72. Preferably, the outer circumferential portions of both of the layers 98, 100 are deflectable and, more preferably, the outer circumferential portion of the main layer 98 is in tight contact with at least a portion of the lower surface 88 of the piston 62. Advantageously, the rigidity of the sub-layer 100 is set lower than that of the main layer 98 so that the sub-layer 100 can deflect more easily than the main layer 98.

With reference still to FIG. 4, the deflection of the valve 94 also can be increased due to the offset “x” between the inner portion of the piston 62 and the outer portion of piston 62. This offset can be increased or decreased and can be adjusted after manufacture by the provision of shims or other spacing members. As will be explained, the offset helps to increase the deflection which helps to tune the pressures at which the respective layers 98, 100 of the valve 94 open.

The main layer takes on a concave appearance as seen from below the threaded member 72. Because a shim 104 is interposed between the inside circumferential portions of the valves 98 and 100, an oil chamber 108 advantageously is formed within the area defined by the concave surface (underside) of the main layer 98 and the top surface of the sub-layer 100 that extends outward to a contact location with the main layer 98. Advantageously, the main layer 98 contains at least one and preferably a number of holes 110 that place the oil chamber 108 in constant fluid communication with the respective set of communication holes 82. This communication allows pressure to be transmitted between the oil chamber 108 and the respective chamber 64 of the respective cylinder 52, 54. The illustrated arrangement also restricts flow into the oil chamber 108 such that pressure can develop within the set of holes 82 that can open the main layer 98 of the valve 94.

With reference again to FIG. 2, the illustrated pressure regulator 56 generally comprises a cylinder 112 having a greater diameter portion 114 and a smaller diameter portion 116. A first piston 118 is disposed within the cylinder and is arranged for relatively free sliding movement within the cylinder 112. The first piston 118 preferably is disposed within the greater diameter portion 114 and is connected to an upwardly extending piston rod 120. An upper portion of the piston rod 120 carries a second piston 122. In the illustrated arrangement, the second piston 122 is secured to the piston rod 120 with a nut 124. The second piston 122 preferably is capable of relatively free sliding movement within the smaller diameter portion 116 of the cylinder 112. Together, the two pistons 118, 122 generally define three chambers: an upper chamber 126, a lower chamber 128 and a gas chamber 130. A removable lower cap 131 further defines the gas chamber 130 in the illustrated arrangement. Other suitable arrangements, such as a permanent lower wall with a recharging nipple or a sealed end cap, can also be used to help form the gas chamber 130.

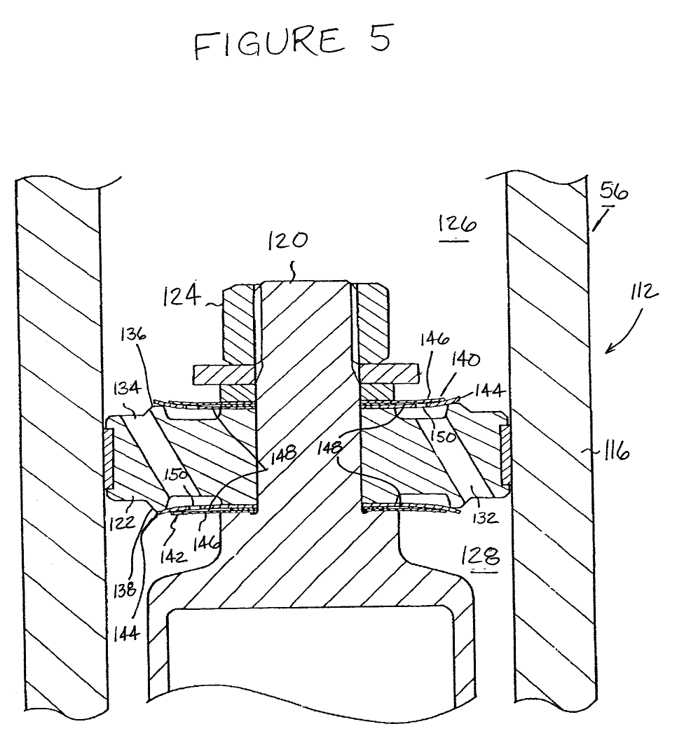

With reference now to FIG. 5, the upper piston 122 in the illustrated arrangement comprises a number of communication holes that extend through the piston 122. In the illustrated arrangement, two sets of holes 132, 134 are defined through the piston 122. Preferably, both sets of holes are disposed generally about a pair of concentric hole circles of the piston 122. Moreover, in the illustrated arrangement, both sets of holes are angled such that the bores defining each of the holes cross in a sectioned elevation view. This arrangement advantageously results in a compact configuration while allowing a single ring-shaped sheet valve to be positioned on each end of the illustrated piston 122. More particularly, in the illustrated arrangement, the piston generally comprises a stepped upper surface 136 and a stepped lower surface 138. A first sheet valve 140 seats against a portion of the upper surface 136 and a second sheet valve 142 seats against a portion of the lower surface 138.

The first sheet valve 140 and the second sheet valve 142 advantageously have an outer diameter that is less than the outer diameter of the piston 122. The sheet valves in the illustrated arrangement are secured about an inner portion (i.e., inner periphery) and the outer portions of the sheet valves are capable of deflection. The sheet valves 140, 142 respectively and selectively close the two sets of communication holes 132, 134.

With continued reference to FIG. 5, the two sheet valves 140, 142 preferably are formed in a similar manner to the valves 92, 94 described above in connection with the damping cylinders 52, 54. Thus, in both sheet valves 140, 142, the valves comprise a main layer 144 and a sub-layer 146. The main layer 144 is interposed between the sub-layer 146 and the piston 122. Due to a preloading of the main layer 144, a slight deflection is set up in the main layer 144. This deflection also can be affected by any offset between the surfaces with which the main layer 144 is in contact and/or by any shims that are used. An oil chamber 148 is defined within an area generally defined between the main layer 144 and the sub-layer 146. A set of orifices 150 place the oil chambers 148 in constant and direct fluid communication with the upper and lower chambers 126, 128 in the illustrated arrangement. The orifices 150 preferably are aligned with the respective sets of holes 132, 134 but need not be. The relative locations of the holes and the orifices can be varied to affect the flow characteristics within the pressure regulator 56. Of course, the sizing of the orifices can be used to control flow through the piston 122 and, therefore, to affect the overall operation of the damper with respect to the speed of movement of the piston and the transition speeds of the piston.

With reference again to FIG. 2, the interior of the pressure regulator contains the upper chamber 126, the lower chamber 128 and the gas chamber 130. The upper and lower chambers 126, 128 preferably are filled with working fluid or working oil, which preferably is no very compressible, while the gas chamber 130 is filled with a compressible gas, such as an inert gas. The piston 122 allows flow between the upper chamber 126 and the lower chamber 128. The piston 118 preferably seals the gas chamber 130 from the lower chamber 128. The upper chamber 126 is connected to one of the dampers 52 through a first fluid line 160 and the lower chamber 128 is connected to another of the damper 54 through a second fluid line 162. The lines 160, 162 can be connected in any suitable manner, such as through the use of nipples, quick disconnect couplings, and the like.

When a four-wheeled vehicle runs on a road and its right and left front wheels move up and down to follow road surface irregularities, the cylinder body 60 and the piston rod 68 of each hydraulic damper 52, 54 extend or contract. For example, when the right and left front wheels run over a bump on a road surface and the piston rods 68 move down by the same amount relative to the cylinder bodies 60 of the right and left hydraulic dampers 52, 54, the pistons 62 connected to the piston rods 68 move down within the cylinder bodies 60.

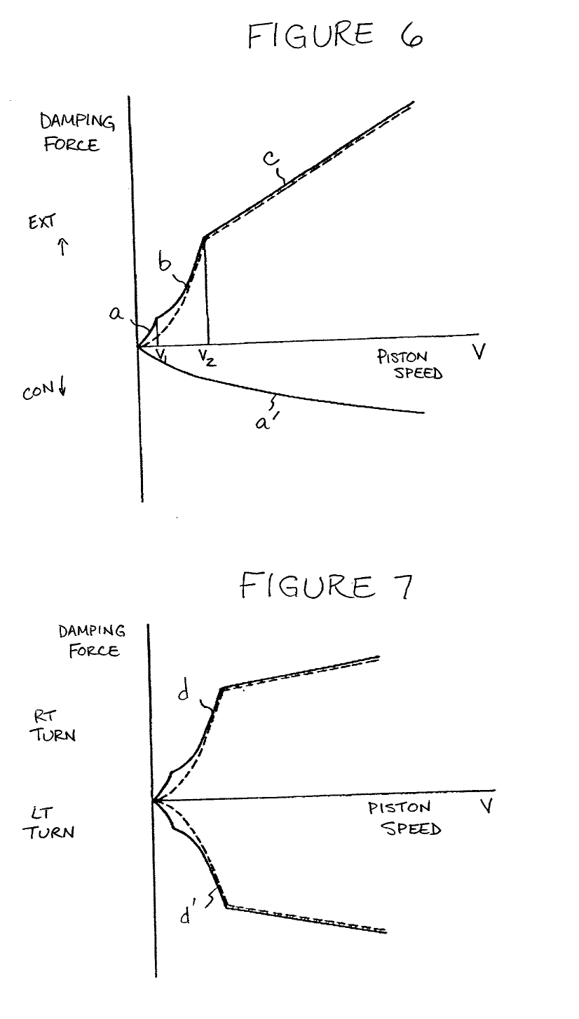

When the piston 62 moves down within the cylinder body 60, working oil in the lower oil chamber 66 flows through the set of communication holes 84 formed in the piston 62 to push open the sheet valve 92 and flows into the upper oil chamber 64. At this time, the natural flow resistance (i.e., viscosity) of the working oil produces a damping force. The damping force (on the compression side) produced at this time is indicated with a solid line (a′) relative to the piston speed (V) in FIG. 6.

At the same time, in the respective cylinders 60, the amount of working oil corresponding to the volume of the portion of the piston rods 68 that enters the cylinder bodies 60 flows from the lower chambers 66 through the hydraulic hoses 160, 162 into the upper and lower oil chambers 126, 128. The pistons 118, 122 move down as a single body in the cylinder 112 to compress the gas in the gas chamber 130. Because the cross-sectional areas of the larger diameter portion 116 and the smaller diameter portion 114 of the cylinder 112 of the pressure regulator 56 are set so that the volumes of the upper oil chamber 126 and the lower oil chamber 128 increase or decrease by the same amount, little working oil flows through the piston 122 between the oil chambers 126, 128. Accordingly, little damping force is produced with the pressure regulator 56 under these operating conditions. Thus, when the right and left front wheels move upward and the right and left hydraulic dampers 52, 54 are compressed by substantially the same amount, bouncing of the vehicle body can be attenuated with a damping force (solid line a′ in FIG. 5) produced as the working oil in each hydraulic cylinder body 60 flows to push-open the sheet valve 92. In this manner, the ride on the vehicle is improved.

In contrast to the above operating condition, when a pair of wheels suspended with the illustrated suspension system run over a recess on the road surface and the piston rods 68 extend (i.e., retract from the cylinder body) by substantially the same travel relative to the cylinder bodies 60, the pistons 62 connected to the piston rods 68 move up within the cylinder bodies 60.

When the pistons 62 move up in the cylinders 60 as described above, the pressure of the working oil in the upper oil chambers 64 increases. Because the oil chamber 108, which is formed between the main layer 98 and the sub-layer 100 of the sheet valve 94, is connected to the upper oil chamber 64 through the orifice 110 formed in the main layer 98 and the set of communication holes 82 formed in the piston 62, the pressure in the oil chamber 108 is the same as that in the upper oil chamber 64. Thus, the pressure in the upper oil chamber 64 is exerted on both the main layer 98 and the sub-layer 100.

In a low speed range, (i.e., where the piston speed V is very small, such as below a preset speed V1 in FIG. 6), the pressure in the upper oil chamber 64 is relatively small so the set of communication holes remain closed by the main layer 98 and the sub-layer 100 of the sheet valve 94. In this speed range, the working oil from the upper oil chamber 64 flows through the orifice 96 bored through the piston 62. Accordingly, a damping force during extension is produced as shown by solid line (a) in FIG. 6.

If the piston speed V increases and exceeds V1, only the pressure in the upper oil chamber 64 opens the sub-layer 100. Thus, the working oil from the upper oil chamber 64 flows through the set of communication holes 82 and the orifice 96 in the piston 62. The working oil also flows through the orifice 110 of the main layer 98, the oil chamber 108, and the sub-layer 100 into the lower oil chamber 66. The flow of the working fluid produces a damping force such as that shown with a solid line (b) in FIG. 6.

If the piston speed V further increases and exceeds V2, both the main layer 98 and the sub-layer 100 of the sheet valve 94 are opened by the pressure in the upper oil chamber 64 and most of the working oil in the upper oil chamber 64 flows through the set of communication holes 82 formed in the piston 5 through the sheet valve 94 into the lower oil chamber 66.Under this condition, a damping force such as that indicated with the solid line (c) in FIG. 6 is produced.

In another mode of operation, such as that which might occur when the vehicle turns, the suspension system behaves somewhat differently. For instance, if the hydraulic cylinder Ion the right hand side contracts and the hydraulic cylinder Ion the left hand side extends (i.e., such as the vehicle body makes aright turn), a damping force such as that indicated with the solid line (a′) in FIG. 6 is produced with the left hand side hydraulic damper 54 and damping forces such as those indicated with solid lines (a, b, and c) in FIG. 6 are produced with the right hand side hydraulic damper 52.

During movement of the pistons 62 and piston rods 68, an amount of working oil flows from the lower oil chamber 66 through the hydraulic hose 162 into the lower oil chamber 128 of the pressure regulator 2. In addition, an amount of working oil flows from the upper oil chamber 126 of the pressure regulator 56 through the hydraulic hose 160 into the lower oil chamber 66 of the hydraulic damper 52. As a result, working oil flows the pressure regulator 56 from the lower oil chamber 128 to the upper oil chamber 126. Of course, this flow can pass through the set of holes 132 and the sheet valve 140. Because the sheet valve 140 is constructed similarly to that in the dampers 52, 54, a damping force indicated with a solid line (d) relative to the piston speed V in FIG. 7 is produced by the pressure regulator 56 as the working oil flows from the lower oil chamber 128 to the upper oil chamber 126. Therefore, rolling of the vehicle body is restricted because extension and contraction of the right and left hydraulic dampers 52, 54 is restricted by the damping force produced within the pressure regulator 56.

When the vehicle makes a left turn and the left side hydraulic damper 54 extends and the right side hydraulic damper 52 contracts, damping forces indicated with solid lines (a, b, and c) in FIG. 6 are produced with the left side hydraulic damper 54 and a damping force shown with the solid line (a′) is produced with the right hand side hydraulic damper 52. An amount of working oil flows from the lower oil chamber 128 of the pressure regulator 56 through the hydraulic hose 162 into the lower oil chamber 66 of the left hand side hydraulic damper 54 to compensate for the withdrawal of a portion of the piston rod 68. In addition, an amount of working oil substantially equal to the amount of the piston rod 68 entering the cylinder body 60 of the right hand side hydraulic cylinder 52 flows from the lower oil chamber 66 of the hydraulic cylinder body 60 through the hydraulic hose 160 into the upper oil chamber 126 of the pressure regulator 56. As a result, working oil flow is produced in the pressure regulator 56 between the upper oil chamber 126 to the lower oil chamber 128. Of course, the working oil flows from the upper oil chamber 126 to the lower oil chamber 128 through the sheet valve 142 and the communication hole 134 of the piston 122. Because the sheet valve 142, which was described above, is similar in construction to the sheet valve 94 in the hydraulic cylinder body 60, a damping force indicated with a solid line (d′) relative to the piston speed V in FIG. 7 is produced by the pressure regulator 56 as the working oil flows from the upper oil chamber to 126 to the lower oil chamber 128. Therefore, rolling of the vehicle body is restricted as extension and contraction of the right and left hydraulic dampers 52, 54 is restricted with the damping force produced in both the dampers 52, 54 and the pressure regulator 56.

The illustrated suspension system provides an arrangement in which shocks are absorbed and attenuated with damping forces produced within the dampers 52, 54 if both dampers 52, 54 extend or contract in the same direction by substantially the same amount. If one of the paired dampers extends while the other contracts, rolling of the vehicle body is restricted by damping forces produced with both the pressure regulator 56 and the respective dampers.

Because the pressure regulator 56 also comprises the sheet valves 140, 142, which are similar to the sheet valves 94 provided in each hydraulic cylinder body 60, the pressure regulator achieves generally the same effect as the effect achieved by the dampers 52, 54.

It is anticipated that the sheet valves also can be constructed in other manners. For instance, in one arrangement, the sheet valves may comprise a main layer that is fixed relative to the piston about an inner portion while the outer portion is deflectable. The sheet valves also may comprise a spacer that extends around an outer portion of the main layer and the sub-layer can be attached to the spacer while being free to deflect about an inner portion. In another arrangement, the main layer could be fixed about its outer periphery and free to deflect about its inner periphery. In such an arrangement, the sub-layer could also be attached about its outer periphery and free to deflect about its inner periphery or the sublayer could be attached about its inner periphery to the deflectable portion of the main layer and free to deflect relative to the fixed portion of the main layer.

Although the present invention has been described in terms of a certain preferred embodiment, other embodiments apparent to those of ordinary skill in the art also are within the scope of the present invention. Thus, various changes and modification may be made without departing from the spirit and scope of the present invention. Accordingly, the scope of the present invention is intended to be defined only by a fair reading and interpretation of the claims that follow.

What is claimed is:

1. An apparatus comprising an outer housing, said outer housing defining at least a first chamber and a second chamber, a moveable wall being interposed between said first chamber and said second chamber, said moveable wall having at least one passage extending in a generally axial direction, said passage in substantially unobstructed fluid communication with said first chamber, a valve member attached to said moveable wall and being positioned between at least a portion of said second chamber and at least a portion of said moveable wall, said valve member selectively closing said at least one passage, said valve member comprising a first layer and a second layer, said first layer being interposed between said moveable wall and said second layer, a chamber being defined between said first layer and said second layer, an opening being defined within said first layer and said chamber being in fluid communication with said passage through said opening.

2. The apparatus of claim 1, wherein at least one of said first layer and said second layer is bent toward the other of said first layer and said second layer to form, at least in part, said chamber.

3. The apparatus of claim 2, wherein said first layer is bent toward said second layer.

4. The apparatus of claim 3, wherein said moveable wall comprises a stepped surface and said stepped surface provides an offset that induces a bend in said first layer.

5. The apparatus of claim 1 further comprising a spacer between said first layer and said second layer.

6. The apparatus of claim 5, wherein said spacer forms, at least in part, said chamber.

7. The apparatus of claim 1, wherein said first layer and said second layer each comprise an inner periphery and said inner periphery is fixed relative to said moveable wall.

8. The apparatus of claim 2, wherein said first layer and said second layer each comprise an outer periphery and said outer periphery is deflectable relative to said moveable wall.

9. The apparatus of claim 1, wherein said first layer comprises an inner periphery and said inner periphery is fixed relative to said moveable wall.

10. The apparatus of claim 1, wherein said second layer comprises an inner periphery and said inner periphery is fixed relative to said moveable wall.

11. The apparatus of claim 1, wherein said first layer has a first modulus of rigidity and said second layer has a second modulus of rigidity and said first modulus of rigidity is greater than said second modulus of rigidity.

12. The apparatus of claim 1, wherein said at least one passage comprises more than two passages formed along symmetrical paths relative to a central axis of said moveable wall.

13. The apparatus of claim 1, wherein said apparatus is a hydraulic damper.

14. The apparatus of claim 13, wherein said hydraulic damper is a portion of a shock absorbing cylinder.

15. The apparatus of claim 13, wherein said hydraulic damper is a portion of a pressure regulator.

16. The apparatus of claim 15 in combination with a pair of shock absorbing dampers, a first of said pair being in fluid communication with said first chamber and a second of said pair being in fluid communication with said second chamber.

17. The apparatus of claim 16, wherein each of said pair comprises an oil chamber-containing sheet valve member.

18. The apparatus of claim 1 in combination with a pressure regulator, wherein said pressure regulator is in fluid communication with at least one of said first chamber and said second chamber.

19. A hydraulic damper comprising a cylinder body, said cylinder body comprising a bore, a piston rod extending into said bore, a piston being connected to said piston rod, said piston containing a first set of passages, said piston substantially separating a first chamber and a second chamber within said cylinder body, said first set of passages extending generally between said first chamber and said second chamber, a first sheet valve selectively opening and closing said first set of passages, and said first sheet valve containing a fluid chamber that is in substantially continuous communication with said first chamber and in selective communication with said second chamber.

20. The damper of claim 19 further comprising a second set of passages and a second sheet valve, said second sheet valve comprising a second fluid chamber that is in substantially continuous communication with said second chamber and in selective communication with said first chamber.

21. The damper of claim 20, wherein said first sheet valve comprises a first layer and a second layer, said first fluid chamber being defined between said first layer and said second layer such that said fluid chamber is in selective communication with said second chamber when said second layer moves away from said first layer.

22. The damper of claim 21, wherein said second sheet valve comprises a first layer and a second layer, said second fluid chamber being defined between said first layer of said second sheet valve and said second layer of said second sheet valve such that said second fluid chamber is in selective communication with said second chamber when said second layer of said second sheet valve moves away from said first layer of said second sheet valve.

23. The damper of claim 20, wherein said first layer abuts at least a portion of said piston and an outer periphery of said first layer is normally deflected outward from said portion of said piston.

24. The damper of claim 19, wherein said fluid chamber openly communicates with said first chamber through at least one opening formed in said first layer.

25. The damper of claim 19, wherein said cylinder body forms a portion of a hydraulic shock absorber.

26. The damper of claim 19, wherein said cylinder body forms a portion of a pressure regulator.

27. A damper comprising a first chamber and a second chamber, a moveable wall being positioned between said first chamber and said second chamber, and means for placing said first chamber and said second chamber in multiple degrees of selective communication such that increasing levels of communication result from increasing pressure differentials in said first and second chambers or increasing speeds of said moveable wall.

28. The damper of claim 27 further comprising a passage extending between said first chamber and said second chamber such that said first chamber and said second chamber are in constant direct communication.
